(19) United States
(12) Patent Application Publication
(10) Pub. No.: US 2003/0105856 A1
(43) Pub. Date: Jun. 5, 2003

(54) Meaningful alarm notification structure for alarm identification

(75) Inventors: Edwin Tse, Montreal (CA); Nicolas Gosselin, Blainville (CA); Andre Godin, Laval (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(73) Assignee: Telefonaktiebolaget L M Ericsson (publ)

(21) Appl. No.: 09/996,727

(22) Filed: Nov. 30, 2001

(51) Int. Cl. G06F 15/173

(52) U.S. Cl. 709/224

(57) ABSTRACT

An alarm notification structure, method, system, and management node for uniquely identifying alarm notifications. When a condition is met, a new alarm notification is created, the alarm comprising a SystemDN field identifying the alarm supplier that created the alarm, an alarm attribute carrying a payload and an alarm identifier field for uniquely identifying the alarm. The alarm identifier field comprises a path portion including a series of nodes corresponding to the path followed by the alarm, and the alarm identification as originally assigned. Each time the alarm is relayed by an intermediate node, that node appends its identity to the path portion of the alarm identifier field. When an operation is performed on the alarm, such as an acknowledgement operation, the alarm identifier field is used and sent in the acknowledgement message, so that intermediate nodes can know the path to be followed back for acknowledging the alarm.

### BACKGROUND OF THE INVENTION

1. Field of the Invention

The present invention relates to network management, and in particular to alarm identification in an alarm management network.

1. Description of the Related Art

Alarm management systems (AMS) are well known concepts. They are network of nodes which function is to acquire alarm notifications from alarm suppliers, process, and relay the alarm notifications to alarm consumers. Alarm Suppliers (ASs) are network elements such as for example nodes, components, or functionalities of the managed system (or network) that are managed, or supervised by a management system. An example of alarm suppliers can be an Alarm Reporter (AR) that produces alarm notifications when pre-selected conditions are met. Alarm Consumers (ACons) are those nodes of the AMS that “consume” alarm notifications, such as for example Alarm Collectors (ACs) that acquire alarm notifications from other nodes, such as for example from alarm suppliers, and that further relay the received alarm notifications to another downstream component of the management system. Other types of alarm consumers, such as for example the Alarm Viewers (AVs), may process and/or display the received alarm notifications for a network operator. Multiple levels of alarm suppliers and consumers may also exist, so that for example, a first alarm consumer may acquire alarm notifications from alarm suppliers, and in turn further relay some alarm notifications to yet another alarm consumer or viewer, i.e. acting as an alarm supplier for the downstream alarm consumer or viewer. In most cases, the AMS is a distributed system, so that its nodes can be deployed on multiple hosts that are physically distributed into a wide geographical area, and can therefore be connected in a cascade configuration. An example of AMS implementation is a distributed fault management system that monitors abnormal conditions of telecommunications networks, fleet management networks, building security systems, and computing systems. In such a configuration, the alarm notifications generated by alarm suppliers (the managed nodes) may carry alarm information and are relayed through the AMS nodes until they reach the appropriate alarm consumer(s).

Reference is now made to FIG. 1 (Prior Art), wherein there is shown a high-level network diagram representative of an AMS (the management system) 10 responsible for supervising a managed network 12. The managed network 12 comprises one or more types of alarm reporters 14ᵢ, such as for example the PC 14₁, the server 14₂, the door access device 14₃, etc. When abnormal conditions occur (such as for example a malfunction of the PC 14₁, or an open condition of device 14₃), alarm reporters 14ᵢ issue alarm notifications 16, which are collected by the AMS 10 and relayed to one or more of the alarm viewers, such as for example to the network management terminal 18, where the alarm information from alarms 16 is displayed, thus allowing a network administrator to take corrective action for dealing with the original abnormal condition that generated the alarms. It is to be noted that the network management terminal 18 is generally understood to be part of the AMS 10, although in FIG. 1 it is illustrated outside the AMS for clarity purposes.

In FIG. 2 (Prior Art) is generic illustration of a monitored network 12, comprising a plurality of alarm suppliers (alarm reporters) 14ᵢ, connected to the AMS 10, and relaying to the AMS alarm notifications 16. In the typical scenario, the alarm notifications are generated by the alarm reporters 14ᵢ that are normally of the same type (e.g. telecommunications nodes, PCs, fleet vehicles, etc) and relayed to the alarm consumers 22ᵢ of the AMS 10.

Reference is now made to FIG. 3.a (Prior Art), wherein there is shown a high-level network diagram illustrative of an exemplary cascade configuration of a management system 29. Alarm reporters 30, 32 and 34 (AR₁, AR₂, AR₃) transmit their corresponding alarms 36, 38, and 40 to the intermediate alarm collector 42 and 44 (AC₁, AC₂), which in turn relay the received alarms to alarm viewer (AV₁) 46. It is to be noted that alarm reporters 30 and 32 relay the flow of alarm notifications 36 and 38 through the alarm collector AC₁ 42, while the alarm reporter 34 relays its alarm notifications 40 through the alarm collector AC₂ 44. Once an alarm notification is received by the alarm viewer 46, such as for example alarm 36, the alarm viewer may perform an operation on the received alarm, such as for example an alarm acknowledgment, which triggers a reply in the form of an alarm acknowledgment message 48, which is sent back to the concerned downstream components, i.e. to the alarm reporter AR₁ 30 via the same path followed by the original alarm 36, i.e. via the alarm collector 42.

Reference is now made to FIG. 3.b (Prior Art), which is a high-level schematic representation of the structure of a prior art alarm notification message 50, similar to alarm notifications 36, 38, and 40 shown in FIG. 3.a. The alarm notification 50 comprises a system distinguished name (SystemDN) field 52 that comprises an identification of the last node of the management system the alarm notification 50 has passed through. For example (not shown in FIG. 3.b), if the alarm is generated by a Node “A” and sent from that Node “A”, the SystemDN field is “A”, while if the alarm is an alarm generated by Node “A”, but further relayed by a Node “B”, then the SystemDN field is “B”. The alarm notification 50 further comprises an alarm identification field 54 typically comprising a unique identification (i.e. “unique” for a given node) of the alarm notification, such as for example the alarm identification string “000505”, and alarm attribute field 56 carrying the alarm notification payload, i.e. for example, a malfunction description.

With reference being now made back to FIG. 3.a (Prior Art), in some instances both alarm reporters 30 and 32 may each issue one alarm notification, and each one of the alarm reporters 30 and 32 may identify the issued alarm using the same alarm identification field set to the same value, for example to “000500”. This is usually due to the fact that each node only insures unique identification of the alarm form its own point of view, without taking into account other nodes identification schemes. If both these alarm notifications are relayed toward the same end-point node, e.g. toward the alarm viewer 46, via the same intermediate node, e.g. via the alarm collector AC₁ 42, after the alarm notifications passes through the alarm collector AC₁, they will both have their system distinguished name field set to “AC₁”, and will therefore be identically identified, having the system distinguished name and the alarm identifier identical with one another. This can create confusion for the recipient node, i.e. for the alarm viewer 46, which when receiving identically identified alarms has no means for adequately distinguishing between them.

Reference is now made to FIG. 3.c (Prior Art), wherein there is shown another high-level network diagram illustrative of another limitation of the prior art scheme for identifying alarm notifications in a network management cascade configuration. Shown in FIG. 3.c are two alarm reporters 30 and 32 (AR₁, AR₂) connected to the alarm collector (AC₁) 42, which is further connected to the alarm viewer (AV₁) 46. When alarm reporter 30 issues an alarm notification 36 following, for example, a detected abnormal condition, the alarm notification 36 is first transmitted to alarm collector 42. At this stage, the alarm notification 36 has its system distinguished name field set to “AR₁”. Alarm collector 42 receives the alarm notification 36, and modifies its distinguished name field by setting it to “AC₁” according to normal procedures, before relaying the alarm notification, now represented by 36′, to the alarm viewer 46. Then, for example following a corrective action taken by the operator of the alarm viewer 46, an alarm acknowledgment message 48 is sent back from the alarm viewer 46 for acknowledging correction of the alarm 36′. The alarm acknowledgment message 48 typically follows the same path, but in the opposite direction, as the alarm notifications 36 and 36′. Therefore, the alarm collector 42 receives the alarm acknowledgment message 48 and since the only meaningful information for identifying the alarm acknowledgment 48 is the one found in the alarm identification field of the alarm acknowledgement message 48, field which is similar to the alarm identification field 54 shown in FIG. 3.b, the alarm collector 42 uses the alarm identification information to fetch from its internal alarm list 60 the system distinguished name of the upstream component to which it must relay the alarm acknowledgment 48. Once the alarm collector 42 identifies that the alarm acknowledgment message 48 is destined to the alarm reporter 30, it relays the acknowledgment message to that alarm reporter. However, the fetch operation performed by the alarm collector on its internal alarm list 60 can be overwhelming for the system resources, especially when dealing with a large number of alarms. The situation is even worse if multiple updates occur concurrently, which require proper synchronization (locking) of the database before each read or write operation. Therefore, the current prior art implementation of using existing alarm identification information for alarm operation purposes is inadequate.

Reference is now made to FIG. 3.d, which is a high-level representation of another limitation of the prior art management networks using the current method for identifying alarms. FIG. 3.d (1) first shows two alarm reporters AR₁and AR₂ connected to an alarm collector AC₁that is in turn connected to an alarm viewer AV₁. Alarms are transmitted is a manner analogous to the one described in the previous figures from alarm reporters to the alarm viewer. In FIG. 3.d (2), alarm collector AC₁ experiences a malfunction, or otherwise becomes unavailable. In order to overcome this obstruction, one possible solution is to instruct alarm reporters AR₁ and AR₂ to connect directly to the alarm viewer AV₁, as shown in FIG. 3.d (3). However, all alarms stored in the alarm viewer AV₁ would bear the alarm collector AC₁ system distinguished name identification in their system distinguished name field, since AC₁ was the last node relaying the alarm notifications toward the alarm viewer. Therefore, since AC₁ system distinguished name identification cannot be used for acknowledgment operations with the alarm reporters, the alarm viewer AV₁ would be required to perform a costly resynchronization of its internal alarm list (not shown), i.e. to delete all the alarm notifications in its list and further request the upload of all alarm notifications from its associated alarm reporters AR₁ and AR₂.

It is thus concluded that the system distinguished name information carried by alarm notifications is changed as the alarm notifications are related from one node to another, and therefore does not provide a reliable identification of alarms in a management system.

Although there is no prior art solution as the one proposed hereinafter for solving the above-mentioned deficiencies, the International Patent Application WO 98/24244, published Jun. 04, 1998 to Croslin, W. (hereinafter called Croslin), bears some relation with the field of the present invention. Croslin teaches a method and apparatus that analyzes network topology data of the telecommunications network, wherein each physically diverse path in the network is assigned a unique path identifier. When a given trunk fails, a computer system compares the path identifiers of the alarming trunks with path identifiers of other routes, such as other trunks, and only those trunks having path identifiers deferring from the path identifier of the alarming trunks are selected as possible restore routes for the failure. However, Croslin's teaching is limited to a method and apparatus for reselecting an alternate path for the transmissions of data, and therefore cannot teach or suggest any method related and to alarm notifications identification.

The International Patent Application WO 96/41440 published Dec. 19, 1996 to Shah, J. (hereinafter called Shah) teaches a method and system for identifying locations of faults causing a circuit malfunction in a communications network. Upon detecting an incoming signal impairment of the circuit, each node first assumes that the failure is on the segment of a circuit immediately upstream thereof, and accordingly sends an identifier of that fault's location to its downstream nodes; each node periodically repeats sending its identifier to its downstream nodes and, when a node has sent its identifier at least a predetermined number of times without receiving a similar identifier from another node upstream, it determines to have sent out an identifier that correctly identifies the fault on the communications circuit. Consequently, Shah is limited to a method and system for finding faulty circuit segments in a telecommunications network, and thus fails to teach or suggest any method related to alarm notifications identification.

Accordingly, it should be readily appreciated that in order to overcome the deficiencies and shortcomings of the existing solutions, it would be advantageous to have a method and system for properly identifying alarm notifications in order to overcome the prior art limitations described hereinabove. The present invention provides such a method and system.

### SUMMARY OF THE INVENTION

The present invention provides a method, system, and management node, and alarm notification structure for uniquely identifying alarm notifications. When a condition is met, a new alarm notification is created, the alarm comprising a SystemDN field identifying the alarm supplier that created the alarm, an alarm attribute carrying a payload and an alarm identifier field for uniquely identifying the alarm. The alarm identifier field comprises a path portion including identifications of a series of nodes corresponding to the path followed by the alarm, and the alarm identification as originally assigned. Each time the alarm is relayed by an intermediate node, that node appends its identity to the path portion of the alarm identifier field. When an operation is performed on the alarm, such as an acknowledgement operation, the alarm identifier field is used and sent in the alarm operation message, so that intermediate nodes can know the path to be followed back for acknowledging the alarm, by extracting the path portion of the alarm identifier field.

Accordingly, in one aspect the present invention provides a method for handling an alarm notification in a management system, the method comprising the steps of:

a) in a first management node of the management system, appending an identification of the first management node to a path portion of an alarm identifier field of the alarm notification;

b) transmitting the alarm notification from the first management node to a third management node of the management system;

wherein the alarm notification comprises a system identification field for identifying a node that lastly handled the alarm notification, the alarm identifier field for identifying the alarm notification, and an alarm attribute field carrying an alarm payload, wherein the alarm identifier field comprises an alarm identifier portion and the path portion having at least one first member related to the identification of the first management node.

In another aspect the present invention provides a management system comprising:

a third management node;

a first management node appending its identification to a path portion of an alarm identifier field of an alarm notification, and sending the alarm notification to the a third management node;

wherein the alarm notification comprises a system identification field for identifying a node that lastly handled the alarm notification, the alarm identifier field for identifying the alarm notification, and an alarm attribute field carrying an alarm payload, the alarm identifier field comprising an alarm identifier portion and the path portion having at least one first member related to the identification of the first management node.

In yet another aspect the present invention provides a first management node acting to handle an alarm notification message, the alarm notification message comprising a system distinguished name field, an alarm identifier field and an alarm attribute field, wherein when handling the alarm notification message, the first management node appends its identification to a path portion of the alarm identifier field.

According to yet another aspect of the invention, there is provided an alarm notification transmitted from a first node to a second node of a management system, the alarm notification comprising:

a system identification field for identifying the first node;

an alarm identifier field for identifying the alarm notification, wherein the alarm identifier field comprises a path portion comprising an identification of a path followed by the alarm notification, and an alarm identification portion comprising an alarm identification assigned by a creator node of the alarm notification; and

an alarm attribute field carrying an alarm payload.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram representative of an Alarm Management System (AMS) responsible for supervising a managed network;

FIG. 2 (Prior Art) is a generic illustration of a monitored network comprising a plurality of alarm suppliers connected to the AMS and relaying alarm notifications;

FIG. 3.a (Prior Art) is a high-level network diagram illustrative of an exemplary cascade configuration of a management system;

FIG. 3.b (Prior Art) is a high-level schematic representation of the structure of a prior art alarm notification message;

FIG. 3.c (Prior Art) is another high-level network diagram illustrative of a limitation of the prior art scheme for identifying alarms in a network management cascade configuration;

FIG. 3.d (Prior Art) a high-level representation of a limitation of the prior art management networks using the current method for identifying alarms;

FIG. 4.a is a is high-level diagram illustrating the structure of an alarm notification message according to the preferred embodiment of the present invention;

FIG. 4.b is a high-level diagram illustrating an exemplary value of the alarm notification message according to the preferred embodiment of the present invention; and

FIG. 5 is a nodal operation and signal flow diagram of a management system implementing the preferred embodiment of the invention.

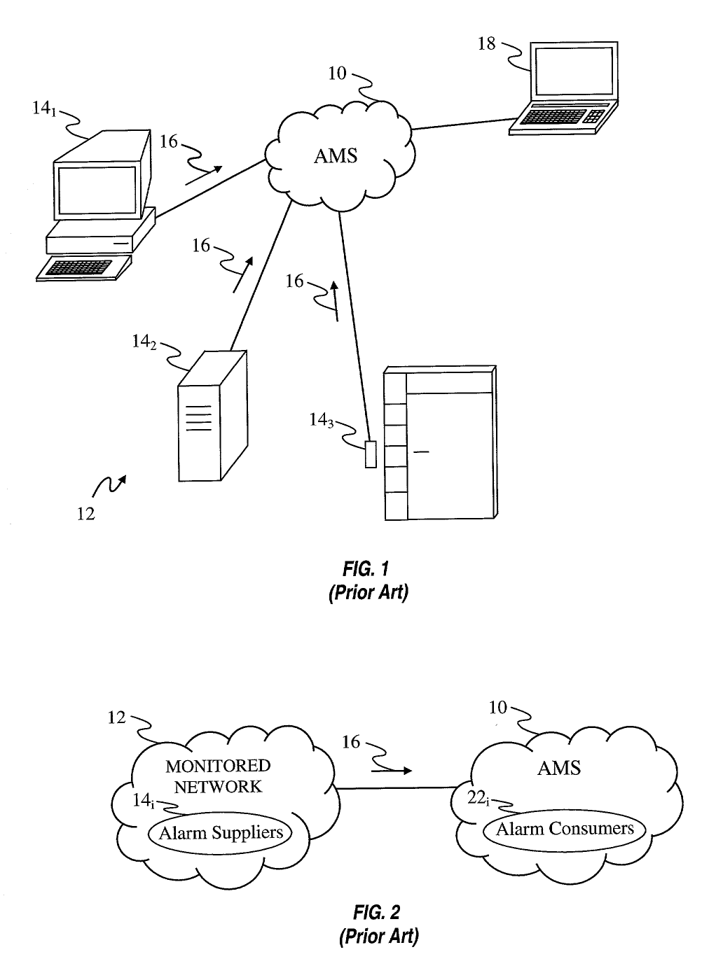

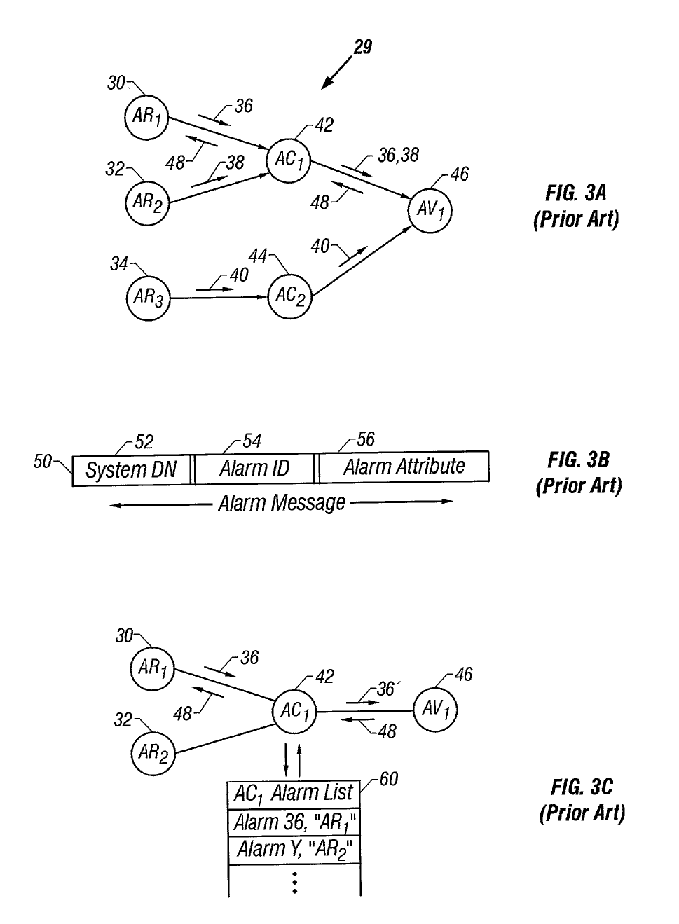

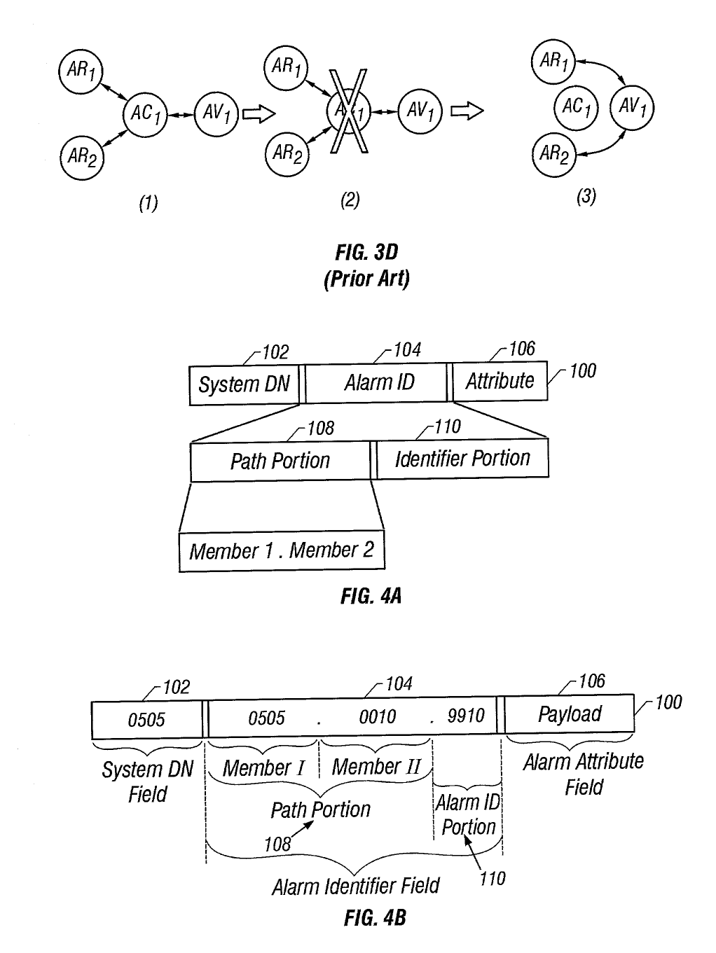

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

The present invention provides a new structure of alarm notification message that allows the nodes of a management systems to unequivocally identify a given alarm notification. The invention also provides a method, system and management node for handling such alarm notifications. According to the preferred embodiment of the present invention, the alarm identifier field of an alarm notification comprises two portions, namely the path portion and the identifier portion. The identifier portion comprises an identification of the alarm that is assigned by the alarm supplier. Its scope of uniqueness is preferably within the internal alarm list of the alarm supplier. The path portion comprises a series of members, wherein each member is an identifier of an alarm supplier. If the alarm is introduced in the system by the alarm supplier itself, i.e. if the system is not forwarding an alarm message, the alarm supplier creates and assigns a value to the alarm identifier portion and places its own identification, such as for example its system distinguished name, into the path portion of the alarm. If the alarm is a forwarded alarm, i.e. it is received by the intermediate alarm supplier from yet another alarm supplier, the intermediate alarm supplier appends its identification, such as for example its own system distinguished name, to the path portion of the alarm identifier field of the alarm. In this manner, according to the preferred embodiment of the invention, the alarm notification that transits through a transmission path involving, for example, three different nodes, comprises an alarm identifier field which path portion comprises a reference to all three different nodes. Thus, recipients of such alarm notifications can unequivocally identify both the original sender of, and a transmission path followed by, such alarm notifications.

Referring now to FIG. 4.a, depicted therein is high-level diagram illustrating the structure of an alarm notification message according to the preferred embodiment of the present invention. The alarm notification 100 comprises a system identification field, such as for example a system distinguished name field 102, for identifying the last node of the management system that carried the alarm notification 100. For example, if the alarm notification 100 is an alarm generated by a given node, the system distinguished name 102 is set to the identity of that given node. Otherwise if for example the alarm notification 100 is an alarm generated by a first node but forwarded by a second node, the system-distinguished name field 102 is set to the identity of the second node. The alarm notification 100 further comprises an alarm identifier field 104 used for unequivocally identifying the alarm, and an alarm attribute field 106 that carries the alarm notification payload. According to the preferred embodiment of the present invention, the alarm identifier field 104 includes a path portion 108, and an identifier portion 110 that comprises a string identifying the alarm 100, which is preferably unique for alarm supplier that introduced the alarm in the network. The path portion 108 comprises a series of members, wherein each member is an identifier of an alarm supplier that handled the alarm 100. In FIG. 4.b, there is shown a high-level diagram illustrating an exemplary value of the same alarm notification message 100 according to the preferred embodiment of the present invention. The alarm notification message 100 was generated by alarm reporter AR1 identified “0010”, which assigned the alarm identifier “9910”to that alarm, which is illustrated after it has been relayed through the alarm collector AC1 identified “0505 for being forwarded to another node. Therefore, the system distinguished name field 102 of the alarm notification 100 is set to “0505” (representing the node that lastly handled the alarm), while the alarm identifier field 104 comprises the string “0505.0010.9910” representing the appended series of members “0505.0010” (the path portion 108) further appended to the identifier portion 110 of that alarm identified by “9910”. The alarm attribute field 106 may comprise a string representing the alarm a payload 106.

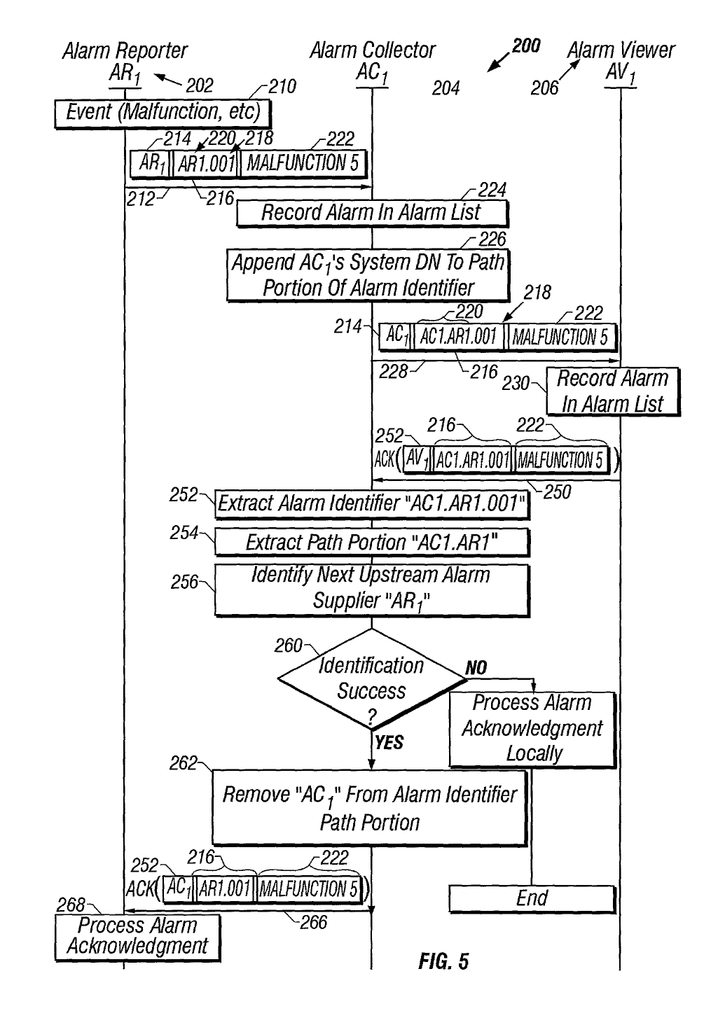

References is now made to FIG. 5, which shows an exemplary nodal operation and signal flow diagram of a management system 200 implementing the preferred embodiment of the invention. The management system 200 comprises an alarm supplier, such as for example the alarm reporter AR₁ 202, an alarm collector AC₁ 204, and an alarm consumer, such as for example the alarm viewer AV₁ 206. First, an event, such as for example a malfunction of a module of AR₁ 202 occurs, action 210, triggering a transmission of an alarm notification 212. According to the given implementation, the alarm notification 212 is transmitted to AV₁ 206 through AC₁ 204. Since the alarm notification 212 is a new alarm introduced in the system 200 by the alarm reporter 202, the former assigns to the alarm's system distinguished name field 214 its own identification, i.e. “AR₁”. The alarm reporter 202 also assigns the value of the alarm identifier field 216, by first assigning a value to the alarm identification portion 218, for example value “001”, and second by appending that value to the path portion 220 of the alarm identifier field 216, which value is set to “AR₁”, i.e. the identification of the alarm supplier handling (i.e., in the present case, that produced) the alarm. The alarm notification 216 also comprises the attribute field 222 carrying the alarm payload, which value is set, for example to “Malfunction 5” for identifying the malfunction that occurred in step 210. In step 224, the alarm collector 204 receives the alarm notification 216 and may optionally record it in its internal alarm list (not shown). According to the preferred embodiment of the invention, in step 226, the alarm collector 204 appends its own identification “AC₁” to the path portion 220 of the alarm identifier field 216, the value of the path portion becoming “AC₁.AR₁”. Therefore, the modified value of the alarm identifier field 216 becomes “AC₁.AR₁.001”. The alarm collector 200 also replaces the system distinguished name value “AR₁” with its own system distinguished name value “AC₁”. The newly formed alarm notification 228 is then sent to the alarm viewer 206, which, upon receipt, may optionally record the alarm notification in its internal alarm list (not shown), action 230. Since alarm notifications like alarm notification 228 are identified not only by an alarm identifier 218 of the alarm itself, but also by the complete connection path 220 the alarm notifications have traveled to reach the end-point node, such alarm notifications are unequivocally identified and all risks of confusions are eliminated.

For example, at a later point in time, for example following a corrective action taken by an operator of the alarm viewer 206, the alarm viewer 206 issues and transmits an alarm operation message, such as for example an alarm acknowledgment message 250 for acknowledging the received alarm notification 228. For that purpose, the alarm viewer 206 may include in the acknowledgment message 250 its own system distinguished name 252, the entire alarm identifier field 216 of the received alarm notification 228, and optionally the value of the alarm attribute field 222. Upon receipt of the acknowledgment message 250, the alarm collector 204 extracts the alarm identifier field 216 from the message 250, action 252, and further extracts the path portion 220 from the field 216, action 254. From the path portion 220, the alarm collector 204 identifies the next upstream alarm supplier that should be contacted for performing the requested operation (in the present case in acknowledgment operation) on the given alarm, action 256. If the identification of action 256 is successfully performed, as detected in action 260, the alarm collector 204 removes its own identification “AC₁” from the alarm identifier path portion 220 of the acknowledgment message 250, replaces in the system distinguished name field 252 the system distinguished name value “AV₁” with its own system distinguished name value “AC₁”, action 262 and sends the modified acknowledgment message 266 to the alarm reporter 202, which upon receipt, locally processes the acknowledgment message 266, action 268, by for example, modifying the status of the alarm in its internal alarm list (not shown). Otherwise, if the identification of action 256 is not successfully performed, or if in operation 260 it is detected that there is no further upstream alarm supplier to be contacted (such as for example in the case of the original alarm was created by the alarm collector 204), the alarm acknowledgment is processed locally, action 264, and the method stops.

Based upon the foregoing, it should now be apparent to those of ordinary skill in the art that the present invention provides an advantageous solution, which offers clear, unique and unequivocal alarm identification. Further, according to the invention there is provided a method, system and node for operating a management system using the invented method for identifying alarms. Although the system, method and management nodes of the present invention have been described in particular reference to certain operations on alarms, such as for example the acknowledgement operation, it should be realized upon reference hereto that the innovative teachings contained herein are not necessarily limited thereto and may be implemented advantageously for other kinds of alarm operations that require unique alarm identification, such as for example an unacknowledged alarm operation, a set alarm comment operation, a clear alarm operation, an assign trouble ticket alarm operation, etc. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow. For example, while the system of FIG. 5 only represents several nodes of given kinds, it is understood that many more nodes of any kind may be involved in the transmission of one given alarm, and that the present invention may be utilized for uniquely identifying alarms in any context in a manner analogous to the one described hereinabove. In particular, the alarm collector 204 may be any one of communications node, alarm supplier, etc, broadly defined herein by the term “management node”. Furthermore, although the appellation used herein referred to a system distinguished name for identifying a management node of the management system in the alarm notification and alarm operations messages, it is understood that other kinds and formats of identification can be used for properly identifying a given management node without departing form the spirit of the invention. It is also understood that the present invention may be applied and constructed using any combination of software, hardware or any combination thereof of modules and components, as preferred by an equipment manufacturer.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for handling an alarm notification in a management system, the method comprising the steps of:
a) in a first management node of the management system, appending an identification of the first management node to a path portion of an alarm identifier field of the alarm notification;
b) transmitting the alarm notification from the first management node to a third management node of the management system;
wherein the alarm notification comprises a system identification field for identifying a node that lastly handled the alarm notification, the alarm identifier field for identifying the alarm notification, and an alarm attribute field carrying an alarm payload, wherein the alarm identifier field comprises an alarm identifier portion and the path portion having at least one first member related to the identification of the first management node.

2. The method for handling the alarm notification as claimed in claim 1, further comprising the step of:
c) inserting an identification of the first management node in the system identification field of the alarm notification.

3. The method for handling the alarm notification as claimed in claim 2, wherein the identification of the first management node is a system distinguished name (SystemDN), and the system identification field is a SystemDN field.

4. The method for handling the alarm notification as claimed in claim 2, wherein the alarm notification is created by the first management node and the path portion of the alarm identifier comprises only one first member comprising the identification of the first management node.

5. The method for handling the alarm notification as claimed in claim 4, wherein the identification of the first management node is a system distinguished name (SystemDN) of the first management node that identifies the first management node.

6. The method for handling the alarm notification as claimed in claim 2, the method further comprising before the step a), the step of:
d) receiving the alarm notification by the first management node from a second management node, the path portion of the alarm identifier of the received alarm notification comprising a second member related to the identification of the second management node;
wherein in step a), the first management node appends the first member comprising its own identification to the path portion of the alarm identifier field of the alarm notification.

7. The method for handling the alarm notification as claimed in claim 6, wherein:
the first member comprises a system distinguished name (SystemDN) of the first management node that identifies the first management node; and
the second member comprises a SystemDN of the second management node that identifies the second management node.

8. The method for handling the alarm notification as claimed in claim 1, the method further comprising the steps of:
e) receiving by the third management node the alarm notification from the first management node;
f) sending an alarm operation message from the third management node to the first management node to instruct an operation regarding the alarm notification, the alarm operation message comprising an alarm identifier field for identifying the alarm notification on which the operation is to be performed which is identical to the alarm identifier field of the alarm notification;
g) upon receipt of the alarm operation message by the first management node, extracting a path portion of the alarm identifier field received in the alarm operation message; and
h) if the extracted path portion comprises not only one first member comprising the identification of the first management node, but also a second member related to the identification of the second management node:
h.1) removing the first member from the path portion of the alarm operation message's alarm identifier field;
h.2) sending from the first management node to the second management node the alarm operation message without the first member in the path portion.

9. The method for handling the alarm notification as claimed in claim 8, further comprising the step of:
i) if the extracted path portion comprises only the first member comprising the identification of the first management node, processing the alarm operation message locally in the first management system.

10. The method for handling the alarm notification as claimed in claim 8, wherein the alarm operation message is an alarm acknowledgement message.

11. The method for handling the alarm notification as claimed in claim 9, wherein the alarm operation message is an alarm acknowledgement message.

12. The method for handling the alarm notification as claimed in claim 10, wherein the step h.2) comprises sending from the first management node to the second management node the alarm acknowledgement message comprising:
the alarm identifier field comprising first, a path portion having the second member related to the identification of the second management node and, second, an alarm identifier portion for identifying the alarm referred to by the alarm acknowledgement message; and
an alarm attribute field carrying an alarm attribute identical to the alarm attribute field of the alarm notification.

13. A management system comprising:
a third management node;
a first management node appending its identification to a path portion of an alarm identifier field of an alarm notification, and sending the alarm notification to the a third management node;
wherein the alarm notification comprises a system identification field for identifying a node that lastly handled the alarm notification, the alarm identifier field for identifying the alarm notification, and an alarm attribute field carrying an alarm payload, the alarm identifier field comprising an alarm identifier portion and the path portion having at least one first member related to the identification of the first management node.

14. The management system as claimed in claim 13, wherein the first management node inserts its own identification in the system identification field of the alarm notification.

15. The management system as claimed in claim 14, wherein the identification of the first management node is a system distinguished name (SystemDN), and the system identification field is a SystemDN field.

16. The management system as claimed in claim 14, wherein the alarm notification is created by the first management node and the path portion of the alarm identifier comprises only one first member comprising the identification of the first management node.

17. The management system as claimed in claim 16, wherein the identification of the first management node is a system distinguished name (SystemDN) of the first management node that identifies the first management node.

18. The management system as claimed in claim 14, further comprising:
a second management node transmitting the alarm notification to the first management node,
wherein the path portion of the alarm identifier of the alarm notification received by the first management node comprises a second member related to the identification of the second management node, and when appending its identification to the path portion of the alarm identifier field of the alarm notification, the first management node appends the first member comprising its own identification.

19. The management system as claimed in claim 18, wherein:
the first member comprises a system distinguished name (SystemDN) of the first management node that identifies the first management node; and
the second member comprises a SystemDN of the second management node that identifies the second management node.

20. The management system as claimed in claim 13, wherein:
the third management node receives the alarm notification from the first management node;
the third management node sends an alarm operation message to the first management node to instruct an operation regarding the alarm notification, the alarm operation message comprising an alarm identifier field for identifying the alarm notification on which the operation is to be performed which is identical to the alarm identifier field of the alarm notification;
upon receipt of the alarm operation message, the first management node extracts a path portion of the alarm identifier field received in the alarm operation message; and
if the extracted path portion comprises not only one first member comprising the identification of the first management node, but also a second member related to the identification of the second management node:
the first management node removes the first member from the path portion of the alarm operation message's alarm identifier field;
the first management node sends to the second management node the alarm operation message without the first member in the path portion.

21. The management system as claimed in claim 20, wherein:
if the extracted path portion comprises only the first member comprising the identification of the first management node, the first management node locally processes the alarm operation message.

22. The management system as claimed in claim 20, wherein the alarm operation message is an alarm acknowledgement message.

23. The management system as claimed in claim 21, wherein the alarm operation message is an alarm acknowledgement message.

24. The management system as claimed in claim 22, wherein the first management node sends to the second management node the alarm acknowledgement message comprising:
the alarm identifier field comprising first, a path portion having the second member related to the identification of the second management node and, second, an alarm identifier portion for identifying the alarm referred to by the alarm acknowledgement message; and
an alarm attribute field carrying an alarm attribute identical to the alarm attribute field of the alarm notification.

25. A first management node acting to handle an alarm notification message, the alarm notification message comprising a system distinguished name field, an alarm identifier field and an alarm attribute field, wherein when handling the alarm notification message, the first management node appends its identification to a path portion of the alarm identifier field.

26. The first management node of claim 25, wherein the alarm notification message is received by the first management node from a second management node and is forwarded by the first management node to third management node, wherein the first management node appends its own identification to the path portion of the alarm identifier field that already comprises an identification of the second management node.

27. The first management node of claim 26, wherein the alarm identifier field of the alarm notification message further comprises a system distinguished name field where the first management node inserts its identification before forwarding the alarm notification to the third node.

28. The first management node of claim 26 receiving from the third node an alarm operation message identified by, and comprising, the alarm identifier field, and upon receipt of the alarm operation message, the first management node removing its own identification from the path portion of the alarm identifier field, and if another node's identification is detected in the path portion, forwarding the alarm operation message without its own identification to a node corresponding to the another node identification.

29. The first management node of claim 26 receiving from the third node an alarm operation message identified by, and comprising, the alarm identifier field, and upon receipt of the alarm operation message, the first management node detecting its own identification from the path portion of the alarm identifier field, and if no another node's identification is detected in the path portion, processing the alarm operation message locally in the first management node.

30. The first management node claimed in claim 28, wherein the alarm operation message is an alarm acknowledgement message.

31. The first management node claimed in claim 29 wherein the alarm operation message is an alarm acknowledgement message.

32. An alarm notification transmitted from a first node to a second node of a management system, the alarm notification comprising:
a system identification field for identifying the first node;
an alarm identifier field for identifying the alarm notification, wherein the alarm identifier field comprises a path portion comprising an identification of a path followed by the alarm notification, and an alarm identification portion comprising an alarm identification assigned by a creator node of the alarm notification; and
an alarm attribute field carrying an alarm payload.

33. The alarm notification claimed in claim 32, wherein the path portion's identification comprises a first member identifying the first node.

34. The alarm notification claimed in claim 33, wherein the alarm is received by the first node from a third node, and the path portion's identification further comprises a second member identifying the third node.

35. The alarm notification claimed in claim 33, wherein path portion's identification comprises a series of members wherein each member identifies each one node the alarm notification traversed.

36. The alarm notification claimed in the claim 35, wherein the alarm identifier field comprises a string of alphanumeric characters identifying the path portion and the alarm identification portion.
